(19) United States
(12) Patent Application Publication
(10) Pub. No.: US 2014/0167695 A1
(43) Pub. Date: Jun. 19, 2014

(54) LOCK DEVICE

(71) Applicant: KABUSHIKI KAISHA TOKAI RIKA DENKI SEISAKUSHO, Aichi (JP)

(72) Inventors: Takahiro SHIMIZU, Aichi (JP); Akihito KIMURA, Aichi (JP); Keiji YAMAMOTO, Aichi (JP); Takashi IEDA, Aichi (JP); Tadayuki TOBIMATSU, Aichi (JP)

(73) Assignee: KABUSHIKI KAISHA TOKAI RIKA DENKI SEISAKUSHO, Aichi (JP)

(21) Appl. No.: 14/096,186

(22) Filed: Dec. 4, 2013

(30) Foreign Application Priority Data
Dec. 13, 2012 (JP) 2012-272506

(51) Int. Cl. B60L 11/18; H01R 13/627; H01R 13/639; H01R 13/447

(52) U.S. Cl. CPC B60L 11/1818; H01R 13/447; H01R 13/6272; H01R 13/6397
USPC 320/109; 439/136; 439/370; 439/304

(57) ABSTRACT

A lock device locks a locking subject to a power port. The lock device is provided with a lock mechanism including a lock member that is movable between a lock position and an unlock position. The lock mechanism moves the lock member to the lock position to lock the locking subject and moves the lock member to the unlock position to unlock the locking subject. A location registration unit registers, as a registered location, a location where switching of the locking subject between a lock state and an unlock state is prohibited or permitted. A location acquisition unit acquires a present location of the lock device. A switching control unit compares the present location with the registered location and controls the lock mechanism based on the comparison to switch the locking subject between the lock state and the unlock state.

### CROSS-REFERENCE TO RELATED APPLICATIONS

This application is based upon and claims the benefit of priority from prior Japanese Patent Application No. 2012-272506, filed on Dec. 13, 2012, the entire contents of which are incorporated herein by reference.

### FIELD

The present invention relates to a lock device that locks and unlocks a locking subject.

### BACKGROUND

Vehicles that emit less carbon dioxide, such as plugin hybrid vehicles and electric vehicles, are environment-friendly and have become popular. Such a vehicle is powered by a battery. When the battery drains after driving the vehicle over a long distance, the battery is recharged. The body of the vehicle is provided with a power port used to charge the battery. A charge cable of a charging facility is connected to the power port to supply power from the charging facility and charge the battery. The battery charging takes a long time. Thus, a charge cable lock device may be used to lock the charge cable to the vehicle body and prevent theft of the charge cable. Japanese Laid-Open Patent Publication No. 2009-081917 describes an example of such a charge cable lock device.

The conventional charge cable lock device locks the charge cable whenever the charge cable is connected to the inlet. However, there are cases in which this may be inconvenient to the user. For example, when the vehicle is parked in a home garage or the like, there would be no need to worry about unauthorized removal of the charge cable. Nevertheless, the charge cable is locked. Thus, after the battery is charged, the user has to unlock the charge cable before driving the vehicle. Such a task may be burdensome to the user.

### SUMMARY

One aspect of the present invention is a lock device for locking a locking subject to a power port. The lock device is provided with a lock mechanism including a lock member that is movable between a lock position and an unlock position. The lock mechanism moves the lock member to the lock position to lock the locking subject and moves the lock member to the unlock position to unlock the locking subject. A location registration unit registers, as a registered location, a location where switching of the locking subject between a lock state and an unlock state is prohibited or permitted. A location acquisition unit acquires a present location of the lock device. A switching control unit compares the present location with the registered location and controls the lock mechanism based on the comparison to switch the locking subject between the lock state and the unlock state.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic perspective view illustrating an inlet arranged in a power port;

FIG. 2 is a schematic side view illustrating a charge cable connected to the inlet of FIG. 1;

FIG. 3 is a schematic block diagram illustrating one embodiment of a lock device;

FIG. 4 is a schematic block diagram illustrating a charge cable lock control executed by the lock device of FIG. 3 when locking is prohibited;

FIG. 5 is a schematic block diagram illustrating a charge cable lock control executed by the lock device of FIG. 3 when locking is permitted;

FIG. 6 is a schematic block diagram illustrating a charge cable unlock control executed by the lock device of FIG. 3;

FIG. 7 is a schematic diagram illustrating an example in which the lock device of FIG. 3 is applied to a lid lock device; and

FIG. 8 is a table of groups of locations associated with valid and invalid locking flags.

### DESCRIPTION OF THE EMBODIMENTS

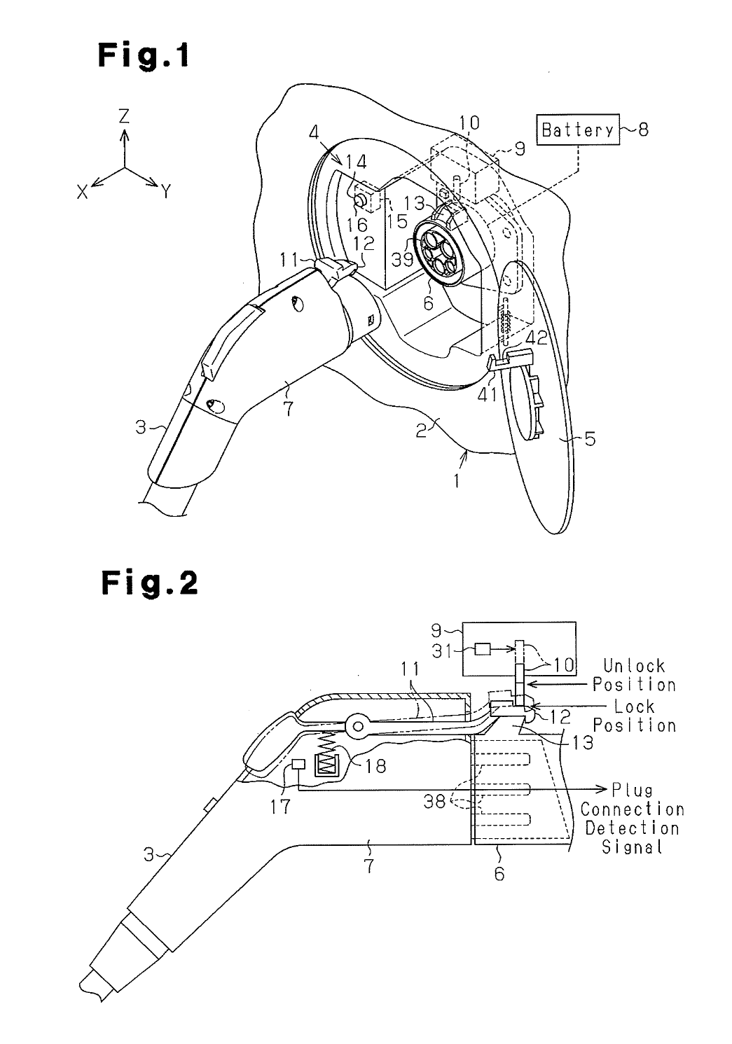

A first embodiment of a lock device will now be described with reference to FIGS. 1 to 6.

Referring to FIG. 1, a battery-driven vehicle 1, such as a plugin hybrid vehicle or an electric vehicle, includes a power port 4 arranged in, for example, a side wall of the vehicle body 2. A charge cable 3 may be fitted into the power port 4. A lid 5, which covers the power port 4, is arranged near the power port 4 to open and close the power port 4. An inlet 6, which serves as a power reception connector, is arranged in the power port 4. A power plug 7, which serves as a power supplying connector, is arranged on the distal end of the charge cable 3 and connectable to the inlet 6. The power plug 7 is connected to the inlet 6 to supply power that charges a battery 8. In the present embodiment, the charge cable 3 corresponds to a locking subject. In another embodiment, the lid 5 corresponds to a locking subject.

In the present embodiment, a lock mechanism 9, which is capable of locking the charge cable 3 to the inlet 6, is arranged in an upper portion of the power port 4. The lock mechanism 9 includes a lock pin 10, which is movable between a lock position and an unlock position, and an actuator 31 (refer to FIG. 2), which moves the lock pin 10. The lock pin 10 is, for example, an elongated member and movable back and forth in the longitudinal direction (Z axis direction in FIG. 1). The power plug 7 includes a pivotal lock arm 11, and the lock arm 11 includes a hook 12 that may be hooked to a catch 13 of the inlet 6. Further, as illustrated in FIG. 2, an urging member 18 is arranged under the lock arm 11 to apply urging force to the lock arm 11 in order to keep the hook 12 hooked to the catch 13. In a state in which the charge cable 3 is connected to the inlet 6 and the hook 12 of the lock arm 11 is hooked to the catch 13 of the inlet 6, the lock mechanism 9 moves the lock pin 10 above the hook 12 to prohibit pivoting of the hook 12 when a given condition is satisfied. This switches the charge cable 3 from an unlock state to a lock state and locks the charge cable 3 to the inlet 6. The lock pin 10 is one example of a lock member.

Referring to FIG. 1, an unlock switch 14 is arranged in the power port 4. The unlock switch 14 may be operated by a user. When operated, the unlock switch 14 outputs an ON signal that activates the lock mechanism 9 to unlock the charge cable 3. The unlock switch 14 is, for example, a push-type memory switch. The unlock switch 14 includes a switch body 15, which is arranged in the vehicle body 2, and a button 16, which is exposed from the vehicle body 2.

Referring to FIG. 2, a plug connection detector 17 is arranged in the power plug 7 to detect connection of the charge cable 3 to the inlet 6. When the charge cable 3 is connected to the inlet 6 and the hook 12 is hooked to the catch 13, the urging force of the urging member 18 holds the lock arm 11 at a close position. The plug connection detector 17 generates a plug connection detection signal when detecting the lock arm 11 at the close position. This indicates that the power plug 7 is connected to the inlet 6, that is, the charge cable 3 is temporarily locked. The plug connection detection signal is transmitted via the inlet 6 to the vehicle 1. The plug connection detector 17 is one example of a temporary lock state

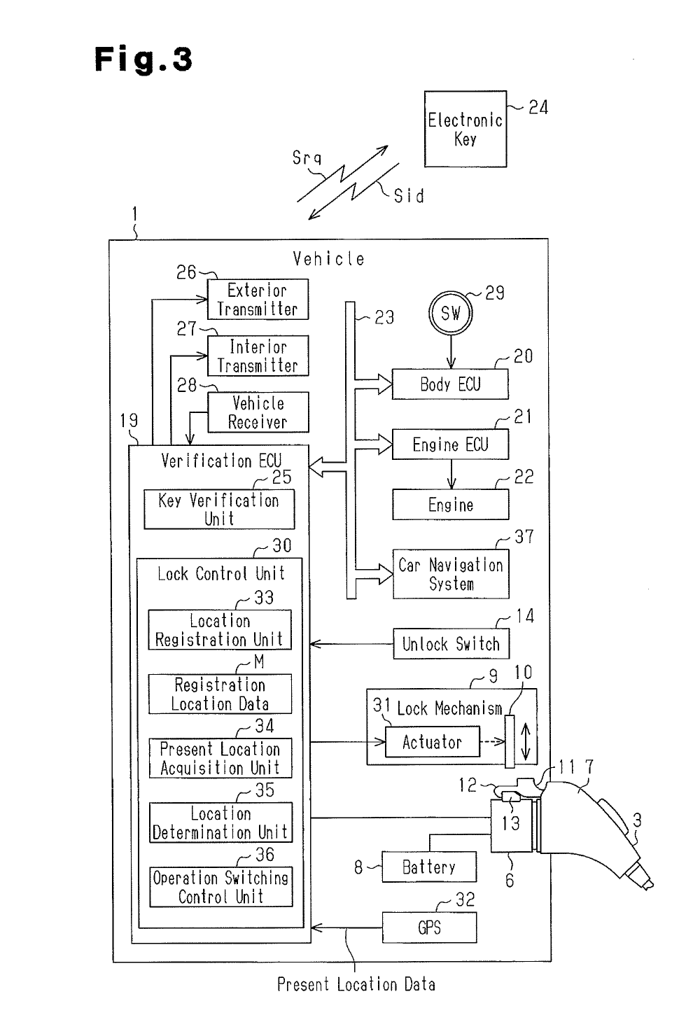

Referring to FIG. 3, the vehicle 1 includes a verification electronic control unit (ECU) 19 that executes various verification controls, a body ECU 20 that manages the power supplied to onboard electric devices, and an engine ECU 21 that controls the engine 22. An in-vehicle bus 23 connects the ECUs 19, 20, and 21. The verification ECU 19 includes a key verification unit 25 that executes ID verification on an electronic key 24 through wireless communication. The verification ECU 19 is connected to an unlock switch 14. Further, the verification ECU 19 is connected to an exterior transmitter 26, which transmits radio waves on the low frequency (LF) band out of the vehicle 1, an interior transmitter 27, which transmits radio waves on the LF band in the vehicle 1, and a vehicle receiver 28, which receives radio waves on the ultrahigh frequency (UHF) band.

An operation-free key system may be used to perform ID verification on the electronic key 24. The operation-free key system performs smart verification to check the ID of the electronic key 24 through bidirectional short-range wireless communication initiated by communication from the vehicle 1. Alternatively, a wireless key system may be used to perform ID verification on the electronic key 24. The wireless key system performs wireless verification to check the ID of the electronic key 24 through short-range wireless communication initiated by communication from the vehicle 1. As another option, a near-distance wireless communication system may be used to perform ID verification on the electronic key 24. The near-distance wireless communication system performs ID verification on the electronic key 24 through bidirectional near-distance wireless (communication distance of several centimeters to several tens of centimeters). An immobilizer system and a near field communication (NFC) system are examples of the near-distance wireless communication system. When the key verification unit 25 determines that ID verification has been accomplished for the electronic key 24 located outside the vehicle 1, the key verification unit 25 permits the locking and unlocking of the vehicle doors. When the key verification unit 25 determines that ID verification has been accomplished for the electronic key 24 located inside the vehicle 1, the key verification unit 25 permits power activation (engine starting) with an engine switch 29, which is arranged near the driver seat.

The verification ECU 19 further includes a lock control unit 30 that controls the lock mechanism 9 to switch the charge cable 3 between a lock state and an unlock state. The lock control unit 30 executes a control for switching the charge cable 3 to the lock state in response to a plug connection detection signal and executes a control for switching the charge cable 3 to the unlock state when the unlock switch 14 is pushed. The lock control unit 30 drives the actuator 31 of the lock mechanism 9 to move the lock pin 10 between the lock position and the unlock position and switch the charge cable 3 between a lock state and an unlock state.

The verification ECU 19 is connected to a Global Positioning System (GPS) receiver 32, which uses satellites to perform measurements for obtaining the present location of the lock device (in the present embodiment, the vehicle 1 that includes the lock device). The GPS receiver 32 transmits the position measurement to the verification ECU 19 as present location data that indicates the present location of the lock device. In the present embodiment, the lock device includes the lock mechanism 9, the lock control unit 30, and the GPS receiver 32.

The lock device of the present embodiment is provided with a determining function that compares the present location of the lock device with a registered location and determines whether to prohibit or permit locking of the locking subject (in the present embodiment, the charge cable 3) based on the comparison result. In one example, the lock control unit 30 includes a location registration unit 33, a present location acquisition unit 34, a location determination unit 35, and an operation switching control unit 36. To facilitate understanding, in FIG. 3, the configuration for realizing the determining function is divided into the functional units 33 to 36. However, two or more of these functional units 33 to 36 may be integrated. Alternatively, at least one of these functional units 33 to 36 may be arranged in a separate control unit that differs from the verification ECU 19. The functional units 33 to 36 may be software or hardware. The location registration unit 33 registers the location of the lock device (i.e., vehicle 1) where the lock mechanism 9 does not necessarily have to be switched to the lock state as the registered location (registered location data). The present location acquisition unit 34 acquires the present location of the lock device from the GPS receiver 32 and provides the location determination unit 35 with the present location as the present location data. The location determination unit 35 compares the present location of the lock device with the registered location and generates a control request signal to prohibit or permit locking in accordance with the comparison. The operation switching control unit 36 receives a plug connection detection signal from the plug connection detector 17 and a control request signal from the location determination unit 35 to control the operation of the lock mechanism 9 based on the plug connection detection signal and the control request signal. In the present embodiment, the GPS receiver 32 and the present location acquisition unit 34 configure a location acquisition unit. Further, the location determination unit 35 and the operation switching control unit 36 configure a switching control unit.

In the present embodiment, when the lock device (vehicle 1) is located at the location registered to the memory M of the verification ECU 19 by the location registration unit 33, the operation switching control unit 36 prohibits locking of the charge cable 3. In this case, even when a plug connection detection signal is received, the operation switching control unit 36 prohibits switching to the lock state. That is, the operation switching control unit 36 does not drive the lock mechanism 9. To register the registered location (registered location data), for example, a dedicated registration tool is connected to the vehicle body 2, and the user operates the registration tool to write the registered location to the ECU 19. As another example of registration, the user operates a car navigation system 37 to write the registered location to the verification ECU 19.

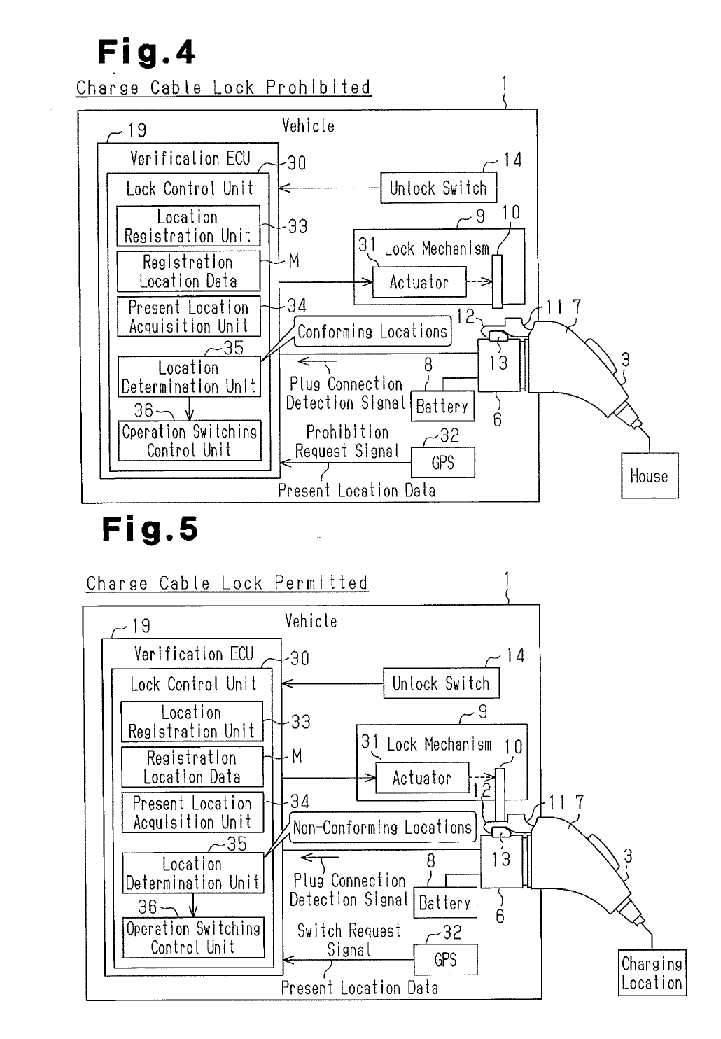

The operation of the lock device will now be described with reference to FIGS. 4 to 6.

[Charge Cable Locking Operation]

As illustrated in FIG. 4, to charge the battery 8 of the vehicle 1, the charge cable 3 is connected to the inlet 6. When the hook 12 of the lock arm 11 is hooked to the catch 13 of the inlet 6, the charge cable 3 is held in a temporary lock state. When the temporary lock state is detected, the plug connection detector 17 transmits a plug connection detection signal via a terminal 39 of the inlet 6 to the verification ECU 19. The plug connection detection signal is provided to the present location acquisition unit 34 and the operation switching control unit 36. In response to the plug connection detection signal, the present location acquisition unit 34 acquires the present location (present location data) of the lock device (vehicle 1) from the GPS receiver 32 and provides the present location data to the location determination unit 35. The location determination unit 35 compares the present location data with the registered location data to determine whether or not the present location of the lock device (vehicle 1) conforms to the registered location.

The location of a home may be given as an example that can be set as a registered location where locking of the charge cable 3 is prohibited. When the vehicle 1 is parked in a home garage, the vehicle 1 is located on private property. Thus, the chances of the charge cable 3 being stolen is low even if the charge cable 3 is not locked when charging the battery 8. Accordingly, by setting the location of a home as the registered location, the charge cable 3 does not undergo unnecessary locking.

When the vehicle 1 is parked in a home, the present location data conforms to the registered location data. In this case, the location determination unit 35 determines that the present location of the lock device (vehicle 1) conforms to the registered location and provides the operation switching control unit 36 with a prohibition request signal (control request signal) that requests for prohibiting locking of the charge cable 3. When receiving the prohibition request signal, the operation switching control unit 36 does not switch the charge cable 3 to be locked even if the operation switching control unit 36 receives the plug connection detection signal from the plug connection detector 17. That is, the operation switching control unit 36 does not drive the lock mechanism 9. Thus, the lock pin 10 remains held at the unlock position. Accordingly, when charging the battery 8 of the vehicle 1 in a home, the charge cable 3 does not undergo unnecessary locking.

Referring to FIG. 5, when the battery 8 of the vehicle 1 is charged at a location that is not set as the registered location, such as at a charging station, the present location data does not conform to the registered location data. Thus, the location determination unit 35 determines that the present location of the lock device (vehicle 1) does not conform to the registered location and provides the operation switching control unit 36 with a switching request signal (control request signal) that requests for the charge cable 3 to be locked.

When the operation switching control unit 36 receives a plug connection detection signal from the plug connection detector 17 and a switching request signal from the location determination unit 35, the charge cable 3 is locked. In this case, the operation switching control unit 36 drives the actuator 31 of the lock mechanism 9 to move the lock pin 10 from the unlock position to the lock position. This moves the lock pin 10 to above the lock arm 11 (hook 12) and locks the charge cable 3 to the inlet 6. As a result, the charge cable 3 cannot be removed from the inlet 6 by an unauthorized person.

[Charge Cable Unlocking Operation]

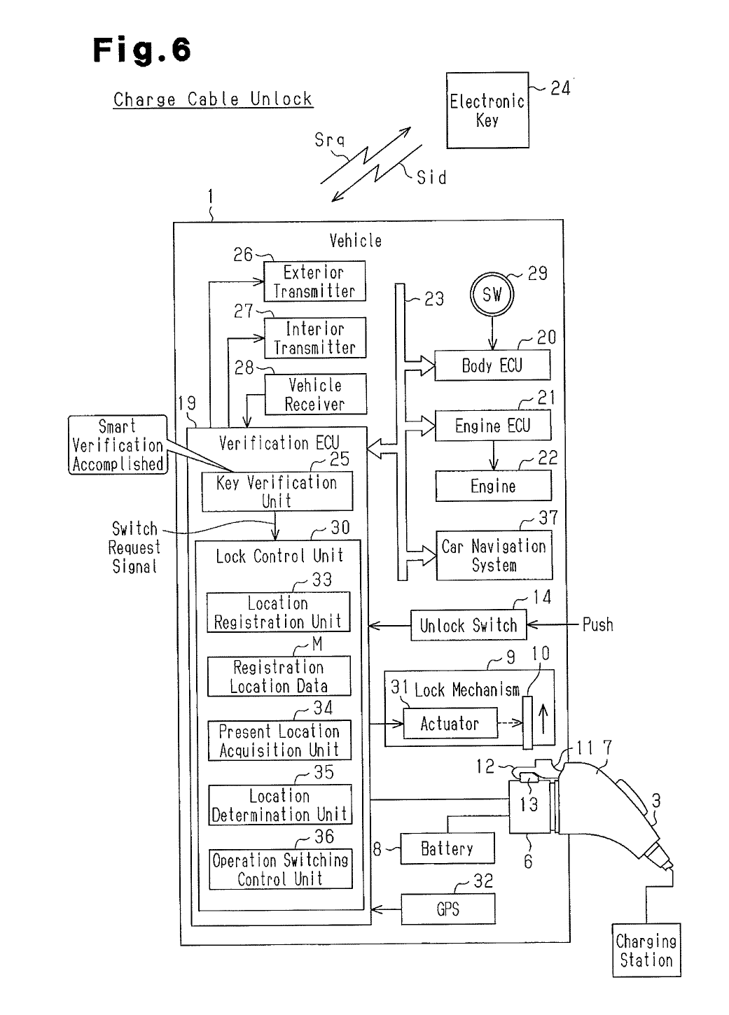

Referring to FIG. 6, after the charging of the battery 8 is completed, the user pushes the unlock switch 14 to unlock the charge cable 3 and remove the charge cable 3 from the inlet 6. When the key verification unit 25 receives a plug connection detection signal from the plug connection detector 17 and an ON signal from the unlock switch 14, the key verification unit 25 performs smart verification on the electronic key 24. When the key verification unit 25 determines that smart verification has been accomplished, the key verification unit 25 provides the lock control unit 30 with a switching request signal that requests for the charge cable 3 to be unlocked.

In response to a switch request signal from the key verification unit 25, the operation switching control unit 36 of the lock control unit 30 unlocks the charge cable 3. In this case, the operation switching control unit 36 drives the actuator 31 of the lock mechanism 9 and moves the lock pin 10 from the lock position to the unlock position. This separates the lock pin 10 from the charge cable 3 (hook 12 of lock arm 11) and unlocks the charge cable 3. As a result, the charge cable 3 may be removed from the inlet 6.

The present embodiment has the advantages described below.

(1) When the charge cable 3 is connected to the power port 4, the lock control unit 30 compares the present location of the lock device (vehicle 1) with the registered location in the memory M. The registered location is set as the location where the lock mechanism 9 is prohibited from locking the charge cable 3. An example of the registered location is the location of a home. Accordingly, when the present location conforms to the registered location, the lock control unit 30 prohibits locking of the charge cable 3. When the present location does not conform to the registered location, the lock control unit 30 permits the lock mechanism 9 to lock the charge cable 3. Thus, by setting the location of a home or the like where there is no need to lock the charge cable 3 as the registered location, unnecessary locking is not performed on the charge cable 3 at the location designated by the user. More specifically, the charge cable 3 is not automatically locked whenever charging the battery 8 of the vehicle 1 with the charge cable 3 at home. Thus, at the registered location such as a home, the charge cable 3 may be locked as intended by the user.

(2) The lock control unit 30 compares the present location, which is acquired from the GPS receiver 32 of the vehicle 1, with the registered location. Thus, the present location of the lock device (vehicle 1) may be easily acquired.

(3) The locking and unlocking of the charge cable 3 may be controlled in cooperation with the locking and unlocking of the vehicle doors. However, in such a case, whenever the vehicle doors are locked or unlocked, the lock mechanism 9 is driven to lock or unlock the charge cable. As a result, the lock mechanism 9 is driven even at locations where there is no need to do so. This may shorten the product life including the lock mechanism 9. In contrast, the lock mechanism 9 of the present embodiment locks the charge cable 3 only at locations designated by the user. This prolongs the product life.

It should be apparent to those skilled in the art that the present invention may be embodied in many other specific forms without departing from the spirit or scope of the invention. Particularly, it should be understood that the present invention may be embodied in the following forms.

In the same manner as the unlock switch 14, a dedicated lock switch operable by the user may be provided. In this case, the charge cable 3 may be locked when the lock switch is operated. The lock switch may be arranged in the power port 4, in the vehicle 1, or on the electronic key 24. For example, when the present location does not conform to the registered location and locking of the charge cable 3 is thus permitted, the operation switching control unit 36 may lock the charge cable 3 when the lock switch is pushed. Further, even if the present location conforms to the registered location and locking of the charge cable 3 is permitted, the operation switching control unit 36 may lock the charge cable 3 when the lock switch is pushed. Alternatively, if an electronic key system, which includes the electronic key 24 and the verification ECU 19, accomplishes ID verification of the electronic key 24 when the present location conforms to the registered location, the charge cable 3 may be locked when the lock switch is operated. Moreover, if the verification ECU 19 receives a plug connection detection signal from the plug connection detector 17 when the present location conforms to the registered location, the charge cable 3 may be locked when the vehicle doors are locked. That is, the locking of the charge cable 3 may be performed in cooperation with the locking of the vehicle doors based on whether or not the present location conforms to the registered location.

The unlocking of the charge cable 3 may be initiated if ID verification of the electronic key 24 is accomplished when the unlock switch 14 is operated. Further, the unlocking of the charge cable 3 may be initiated if the vehicle doors are unlocked when the verification ECU 19 receives a plug connection detection signal from the plug connection detector 17. In other words, the charge cable 3 may be unlocked in cooperation with the unlocking of the vehicle doors.

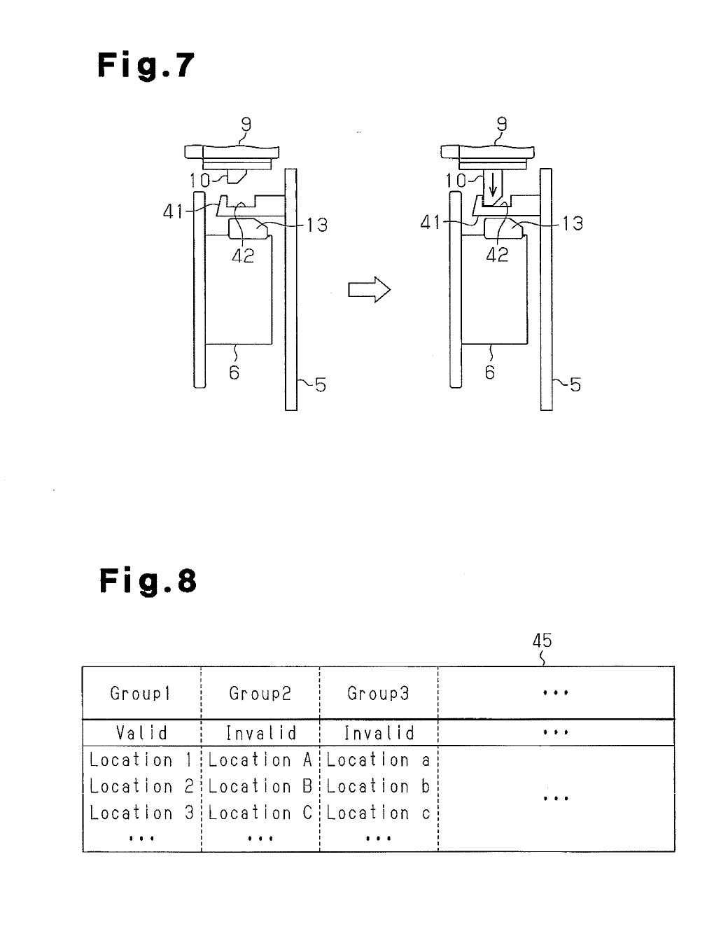

The lock device does not have to lock the charge cable 3. For example, referring to FIG. 7, the lock device may lock and unlock the lid 5. In this case, the lid 5 corresponds to the locking subject. For example, as illustrated in FIG. 1, a striker 41 including a groove 42 is arranged on the rear surface of the lid 5. Referring to FIG. 7, when the lid 5 is closed (temporarily locked), the lock device engages the lock pin 10 with the groove 42 of the striker 41 to lock the lid 5. In this case, the lock device includes a lid close detector (temporary locking detector) that detects when the lid 5 is closed (temporarily locked) instead of the plug connection detector 17.

In the embodiment illustrated in FIG. 7, the lid 5 may be unlocked when, for example, a lid unlock switch arranged in the vehicle 1 is operated and/or when the closed lid 5 is pushed further inward under a situation in which the ID of the electronic key 24 is verified.

When the lid 5 is closed, the lid 5 may be locked based on the comparison of the present location and the registered location. In this case, like the above embodiment, the locking of the lid 5 is prohibited when the present location conforms to the registered location, and the locking of the lid 5 is permitted when the present location does not conform to the registered location. Alternatively, when the lid 5 is closed, the lid 5 may be locked in cooperation with the locking of the vehicle doors based on the comparison of the present location and the registered location. Moreover, the lid 5 may be locked in accordance with whether or not the electronic key system accomplishes ID verification of the electronic key 24.

Referring to FIG. 8, the memory M may store a table 45 of groups of one of more registered locations. The location determination unit 35 refers to the table 45. Valid and invalid flags are set for each group in the table 45. A valid flag indicates that the locking and unlocking control based on the comparison of the present location and the registered location is valid. An invalid flag indicates that the locking and unlocking control based on the comparison of the present location and the registered location is invalid. For example, when the present location conforms to location 1 that is registered under group 1, the operation switching control unit 36 executes control based on the location comparison from the location determination unit 35. In this case, for example, locking of the charge cable 3 is prohibited. In another example, when the present location conforms to location A that is registered under group 2, the operation switching control unit 36 executes control without referring to the location comparison. In this case, the charge cable 3 is automatically locked when connected to the inlet 6. The registered locations and flags may be set in the table 45 using the functions (facility setting function) of the car navigation system 37. The use of the table 45 allows for a plurality of charging stations or the like to be simultaneously registered as locations where the charge cable 3 is automatically locked.

The user may be notified of a location comparison result or an operation completion result of the lock mechanism 9 through, for example, the car navigation system 37 or the electronic key 24.

In the above embodiment, a location where the locking of the charge cable 3 is prohibited is set as the registered location. However, a location where the locking of the charge cable 3 is permitted may be set as the registered location. In this case, when the present location conforms to the registered location, locking of the charge cable 3 is permitted.

The operation switching control unit 36 may be configured to permit locking of the charge cable 3 over a predetermined period of time or for a predetermined number of times when a certain operation is performed at a location where locking of the charge cable is prohibited. For example, the certain operation may be a predetermined number of pushes or a long push of the lock switch (or unlock switch 14). In this configuration, even when the locking of the charge cable 3 is prohibited, the charge cable 3 may be locked as intended by the user. Further, the operation switching control unit 36 may be configured to prohibit locking of the charge cable 3 over a predetermined period of time or for a predetermined number of times when a certain operation is performed at a location where locking of the charge cable is permitted.

A transmission antenna for ID verification may be arranged in the power port 4. A lock ECU, which differs from the verification ECU 19, may be used to control the locking and unlocking of the charge cable 3. In this case, the lock ECU may include the functional units 33 to 36 and the memory M.

The registration of a location to the memory M does not have to be performed with a dedicated registration tool or the car navigation system 37 and may be performed with, for example, a smartphone.

The present location data does not have to be acquired from the GPS receiver 32 of the vehicle 1 and may be acquired from other instruments or terminals.

Various drive sources, such as a motor or a solenoid, may be used as the actuator 31 of the lock mechanism 9.

One of locking and unlocking may be performed with a manual operation member, and the other one of locking and unlocking may be performed with only the lock device. Alternatively, locking and unlocking may both be performed with a manual operation member.

The lock device may have any structure as long as a lock member may be moved between a lock position and an unlock position. Thus, the lock member is not limited to the movable lock pin 10. For example, the lock member may be a pivotal cylindrical member including a cutout portion. In this case, when the lock member is located at a lock position, the portion of the lock member where the cutout portion is not formed restricts movement of the lock arm 11. When the lock member is located at the unlock position, the cutout portion of the lock member allows for movement of the lock arm 11. In another example, the lock member may be triangular plate pivoted between a lock position and an unlock position.

The lock mechanism 9 may include an urging member that biases the lock member (for example, the lock pin 10) to the unlock position. Alternatively, the lock mechanism 9 may include an urging member that biases the lock member to the lock position.

The lock mechanism 9 may include a pivotal support member directly connected to the lock pin 10. In this configuration, the lock mechanism 9 pivots the support member to move the lock pin 10 between the lock position and the unlock position. In this case, for example, the lock pin 10 includes a projection, and the cylindrical support member includes a sloped groove. The projection of the lock pin 10 is supported to be movable in the groove of the support member. When the support member is pivoted, the projection moves along the groove. This moves the lock pin 10 between the lock position and the unlock position.

The lock mechanism 9 may be configured to directly hook the lock pin 10 to, for example, the housing (main body) of the power plug 7.

A single lock device (lock mechanism 9 including the lock pin 10 and the actuator 31) may be used to selectively lock one of the charge cable 3 and the lid 5.

The locking subject does not have to be the charge cable 3 or the lid 5, and may be another component related with the power port 4 of the vehicle 1, which includes the battery 8.

The lock device may be dedicated to lock the charge cable 3 or dedicated to lock the lid 5. In any case, the lock device only needs to be arranged in the power port 4.

In the above embodiment, locations are compared to perform locking. However, locations may be compared perform unlocking. Alternatively, locations may be compared to perform both locking and unlocking.

The lock device is not limited to the vehicle 1 and may be installed in other instruments or machines.

The present examples and embodiments are to be considered as illustrative and not restrictive, and the invention is not to be limited to the details given herein, but may be modified within the scope and equivalence of the appended claims.

1. A lock device for locking a locking subject to a power port, the lock device comprising:
a lock mechanism including a lock member that is movable between a lock position and an unlock position, wherein the lock mechanism is configured to move the lock member to the lock position to lock the locking subject, and configured to move the lock member to the unlock position to unlock the locking subject;
a location registration unit configured to register, as a registered location, a location where switching of the locking subject between a lock state and an unlock state is prohibited or permitted;
a location acquisition unit configured to acquire a present location of the lock device; and
a switching control unit configured to compare the present location with the registered location and control the lock mechanism based on the comparison to switch the locking subject between the lock state and the unlock state.

2. The lock device according to claim 1, wherein the location acquisition unit includes a GPS receiver configured to acquire present location data.

3. The lock device according to claim 1, wherein the locking subject is a charge cable configured to supply power to a battery of a vehicle.

4. The lock device according to claim 1, wherein the locking subject is a lid, covering the power port, configured to open and close the power port.

5. The lock device according to claim 1, wherein the switching control unit is configured so that when a certain operation is performed at a location where switching of the locking subject between the lock state and the unlock state is prohibited, the switching control unit permits the switching of the locking subject between the lock state and the unlock state over a predetermined period of time or for a predetermined number of times.

6. The lock device according to claim 1, wherein the switching control unit is configured so that when a certain operation is performed at a location where switching of the locking subject between the lock state and the unlock state is permitted, the switching control unit prohibits the switching of the locking subject between the lock state and the unlock state over a predetermined period of time or for a predetermined number of times.

7. The lock device according to claim 1, further comprising
a temporary lock state detector configured to detect whether or not the locking subject is temporarily locked to the power port,
wherein the switching control unit includes
a location determination unit configured to compare the present location with the registered location and generate a control request signal for prohibiting or permitting switching of the locking subject to the lock state in accordance with the comparison, and
an operation switching control unit configured to receive a plug connection detection signal from the temporary lock state detector and the control request signal from the location determination unit and control the lock mechanism based on the plug connection detection signal and the control request signal.
